(19) United States
(12) Patent Application Publication
(10) Pub. No.: US 2016/0347265 A1
(43) Pub. Date: Dec. 1, 2016

(54) COVER FOR VEHICLE INTERIOR LINING COMPONENT

(71) Applicant: Pecca Leather Sdn Bhd, Kuala Lumpur (MY)

(72) Inventors: HWA CHENG TEOH, KUALA LUMPUR (MY); CHEE KENG SAM, KUALA LUMPUR (MY); CHEN XIANG WONG, KUALA LUMPUR (MY)

(21) Appl. No.: 15/235,661

(22) Filed: Aug. 12, 2016

Related U.S. Application Data
(63) Continuation-in-part of application No. 14/006,762, filed on Nov. 6, 2013.

(30) Foreign Application Priority Data
Mar. 23, 2011 (MY) PI2011001296

(51) Int. Cl. B60R 13/02; B29C 45/00; B29C 43/56; B29C 43/02; B32B 3/06; B32B 37/12; B32B 37/18; B32B 9/02; B32B 9/04; B32B 27/08; B32B 27/12; B32B 27/30; B32B 27/40; B32B 27/36; B32B 7/12

(52) U.S. Cl. CPC B60R 13/0275; B60R 13/0206; B32B 7/12; B29C 45/0053; B29C 43/56; B29C 43/02; B32B 3/06; B32B 37/12; B32B 37/182; B32B 9/025; B32B 9/045; B32B 27/08; B32B 27/12; B32B 27/304; B32B 27/40; B32B 27/302; B32B 27/36; B32B 27/365; B29C 2045/0079; B29L 2031/3005

(57) ABSTRACT

An interchangeable cover for at least a portion of a vehicle interior lining component comprising a molded base having an interior contour corresponding to an exterior shape of the component to be covered, a plurality of fixing means for mounting the cover over the component, and a facing sheet attached to an exterior surface of the base.

### CROSS-REFERENCE TO RELATED APPLICATION

The instant application is a continuation-in-part of U.S. patent application Ser. No. 14/006,672 filed Nov. 6, 2013, pending, a national phase of PCT International Patent Application Serial No. PCT/MY2011/000189 filed Aug. 15, 2011, and claims priority to Malaysian Patent Application Serial No. PI 2011001296 filed Mar. 23, 2011, the entire specifications of all of which are expressly incorporated herein by reference.

### FIELD OF THE INVENTION

This invention generally relates to a protective cover. More particularly, the present invention relates to an interchangeable cover for a vehicle interior lining component and a method of producing thereof that could be fast and closely attached and fitted to an original or existing lining component.

### BACKGROUND OF THE INVENTION

Typical vehicles, especially motor vehicles, such as cars and motorcycles, have a plurality of vehicle interior lining components such as a door trim panel, a dashboard, a parking brake handle, a steering, or the like. The interior lining components are usually made from decorative plastic material or originally covered with a layer of fabric which can improve the aesthetic value of the vehicle interior. However, the plastic material is prone to damage under harsh sunlight and shock while fabric is prone to staining especially when someone accidentally pours colored liquid on it. Generally, the outer appearance of the vehicle interior trim components deteriorates through time.

In order to solve the abovementioned problems, the vehicle interior lining component is replaced with a new one which has an identical shape and size to the original vehicle interior lining component. The new vehicle interior lining components may be made from a more durable material or covered with leather instead of fabric to improve the outer appearance of the vehicle interior lining. Such a method may be a great idea to prevent deleterious factors such as split dirt, wetness, friction, or harsh sunlight from destroying the vehicle interior lining components and thus increasing its durability. Further, it allows various designs of the vehicle interior lining component to accommodate different lifestyles of a user.

However, such method is very costly, complicated, time-consuming, and requires highly skilled personnel. In order to fabricate a new vehicle interior lining component, the original interior lining component has to be removed for molding the new interior lining component. Thereafter, the new interior lining component can be assembled to the vehicle interior in order to re-configure the interior lining. Such method can provide a close-fit between the interior lining component and the vehicle interior. However, the interior lining component is not interchangeable and detachable because dismantle of the existing lining component and assemble of a new lining component are not convenient.

Methods have been developed so that the new interior lining component can be molded without the need of dismantling the existing interior lining component. The new interior lining component is molded with a desired material, directly on the desired location of the vehicle interior, pressed fit, and retained in place thereon after the molding process. Likewise, the new interior lining component produced therefrom has an identical shape and size as the original interior lining component and therefore a close-fit between the new interior lining component and the vehicle interior is possible. Nevertheless, such method does not solve the abovementioned problems of assembling and dismantling of the interior lining component.

In view of the drawback of the existing technology, there is a need to develop a method for protecting and improving the outer appearance of the original or existing vehicle interior lining component which eliminates the need of dismantle the original lining component. Particularly, a cover which can be closely fitted to the lining component via a simple, fast, and cheap procedure is desired. The cover shall be interchangeable to promote hygiene in the internal environment of the vehicle.

This invention provides a solution to the aforementioned problems.

### SUMMARY OF THE INVENTION

One of the objects of the invention is to provide an interchangeable cover for a vehicle interior lining component which can be easily and closely fitted to the desired lining component of the vehicle interior.

Another object of the invention is to protect the original vehicle interior lining component as well as to improve the outer appearance of the original lining component by assembling an interchangeable cover thereon.

Still another object of the invention is to provide an interchangeable cover for a vehicle interior lining component that does not incur or only incur minimum adverse effect on the original vehicle interior lining component.

Yet another object of the invention is to provide a simple and fast method of producing an interchangeable cover for a vehicle interior lining component.

At least one of the preceding aspects is met, in whole or in part, by the present invention, in which the embodiment of the present invention describes an interchangeable cover for at least a portion of a vehicle interior lining component comprising a molded base having an interior contour corresponding to an exterior shape of the component to be covered, a plurality of fixing means for mounting the cover over the component; and a facing sheet attached to an exterior surface of the base.

In a preferred embodiment of the invention, the fixing means may be a double-sided tape or a hook-and-loop fastener on the interior contour of the base.

In another preferred embodiment of the invention, the fixing means may be a clip or a hook, which extends outwardly along the periphery of the base. Preferably, the fixing means may be integral with the base. When the cover is mounted to the component, the fixing means may engage with a slot formed between the periphery of the component and the rest of the vehicle interior, in such a manner that it is not visible after mounting the cover to the component.

Still in another preferred embodiment of the invention, the base may be made from polyethylene terephthalate (PET), acrylonitrile butadiene styrene (ABS), polypropylene (PP), or polycarbonate (PC) while the facing sheet may be made from leather, polyvinylchloride (PVC), polyurethane (PU), fabric, or microfiber.

A further embodiment of the invention is a method of producing an interchangeable cover for at least a portion of a vehicle interior lining component, as described in any of the preceding description, comprising the steps of molding a base over an original vehicle interior lining component so that it has an interior contour corresponding to an exterior shape of the component to be covered, attaching a facing sheet to an exterior surface of the base, and providing a plurality of fixing means for mounting the cover over the component.

In a further embodiment of the invention, the component may be preferably remote from a vehicle during molding. Preferably, the base may be removed from the component after molding.

In another further embodiment of the invention, the facing sheet may be attached to the base before or after assembling the cover to the vehicle. Preferably, the sheet may be attached to the base by an adhesive. More preferably, the sheet may be adhered to the base by press forming or vacuum forming.

The preferred embodiment of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a perspective front view of the cover with a facing sheet engages over a base, showing that the facing sheet has a slightly larger surface area than the base, as embodied by one of the preferred embodiments of the invention.

FIG. 2A is a perspective front view, and FIG. 2B is a perspective back view, of the cover in FIG. 1, showing a base attached and wrapped with a facing sheet, as embodied by one of the preferred embodiments of the invention.

FIG. 3A is a perspective front view, and FIG. 3B is a perspective back view, of the cover in FIGS. 2A and 2B attached with a plurality of fixing means, as embodied by one of the preferred embodiments of the invention.

FIG. 4A and FIG. 4B show two exemplary fixing means as embodied by one of the preferred embodiments of the invention.

FIG. 5A is a front view, and FIG. 5B is an enlarged perspective front view, of the cover over a vehicle interior lining component, as embodied by one of the preferred embodiments of the invention.

### DETAILED DESCRIPTION OF THE INVENTION

This invention relates to a protective cover. More particularly, the present invention relates to an interchangeable cover for a vehicle interior lining component and a method of producing thereof that could be fast and closely attached and fitted to an original or existing lining component.

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claims.

The invention discloses an interchangeable cover for at least a portion of a vehicle interior lining component comprising a molded base having an interior contour corresponding to the exterior shape of the component to be covered, a plurality of fixing means for mounting the cover over the component, and a facing sheet attached to the exterior surface of the base.

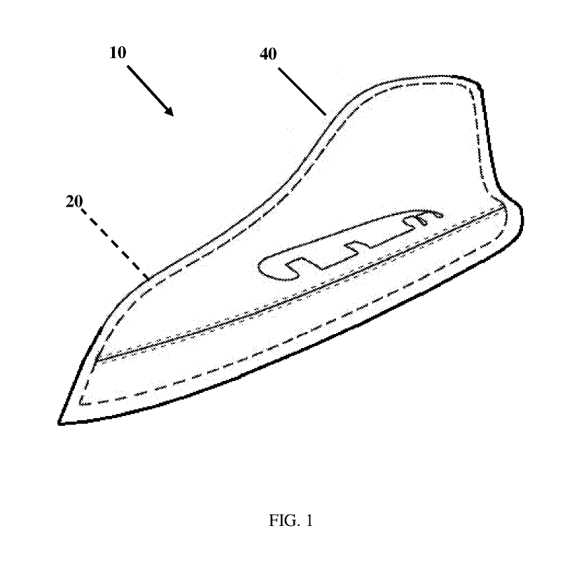

Conventionally, a vehicle interior comprises various lining components, hereinafter refers as “vehicle interior lining component,” “lining component,” or “component,” that cover various parts of the vehicle interior as a means for improving the outer appearance of the vehicle interior as well as for protecting elements beneath the lining component. The lining component includes, but is not limited to, a door trim panel, a dashboard, a steering wheel, a door handle, a brake handle, or an armrest. Instead of replacing the lining component, the present invention provides an interchangeable cover that can be mounted over the original or existing lining component, thereby saving cost, labor, and time. For ease of illustration, the lining component described in the following description would be referred to a vehicle door trim panel. The following description shall make reference to non-limiting FIGS. 1 to 5B.

In a preferred embodiment of the invention, the cover (10) spans at least a portion of the exterior surface of the lining component (50) such that the lining component (50) is only partially covered. More preferably, the cover (10) spans the whole exterior surface of the lining component (50) so that the whole lining component (50) is covered. In most vehicle interiors, a joint between the periphery of the lining component (50) and the rest of the vehicle interior may have a slot (60) formed therebetween, defining a narrow slit-like space around the periphery of the lining component (50). However, some vehicle interiors may have a slot-less joint.

The cover (10) comprises a base (20) having a first surface as an interior surface and a second surface as an exterior surface. The base (20) may be molded in such a way that the interior surface has a contour that corresponds to an exterior shape of the lining component (50) to be covered. The exterior surface of the base (20) may be contoured in any shape depending on the desired outer appearance of the cover (10) to be presented in the vehicle interior. However, it is preferable to have a flat exterior surface that has a similar exterior shape to the original or existing lining component for ease of attachment of a decorative material thereon. Preferably, the base (20) may be made from a thermoplastic material, particularly, polyethylene terephthalate (PET), acrylonitrile butadiene styrene (ABS), polypropylene (PP), or polycarbonate (PC). The base (20) may serve as a supporting or backing material for a facing sheet (40) to be attached to.

According to the preferred embodiments of the invention, the cover (10) comprises a facing sheet (40) attached to the exterior surface of the base (20) that does not engage over the lining component (50). The facing sheet (40) may be preferably decorative so that it may provide an improved outer appearance of the vehicle interior when the cover (10) is mounted to the lining component (50). Preferably, the facing sheet (40) may be made from leather, polyvinylchloride (PVC), polyurethane (PU), fabric, or microfiber. Leather may be particularly preferred as it may be easy to maintain and provides satisfactory aesthetic appearance demanded by most vehicle users.

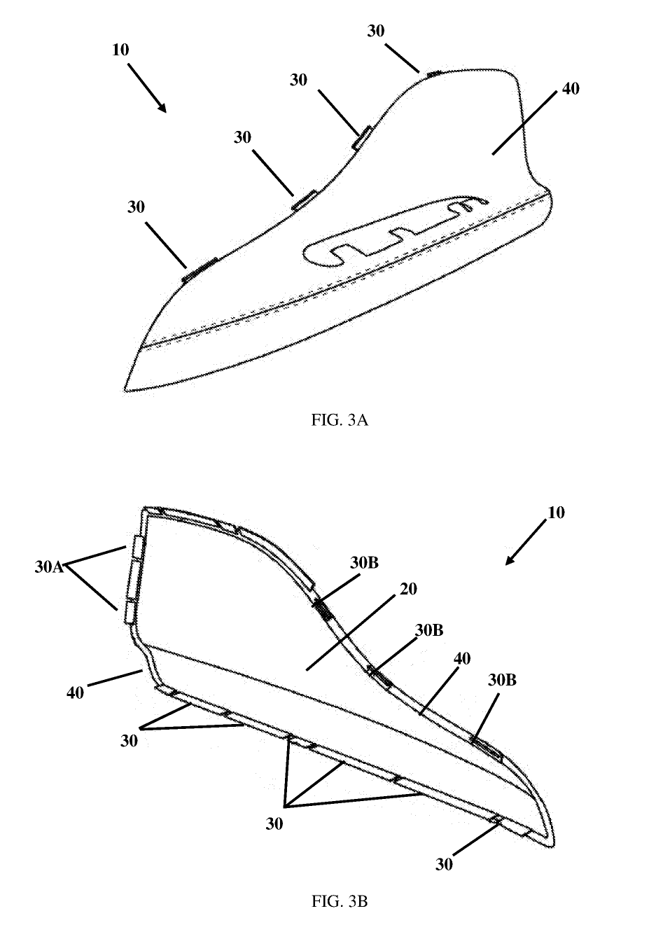

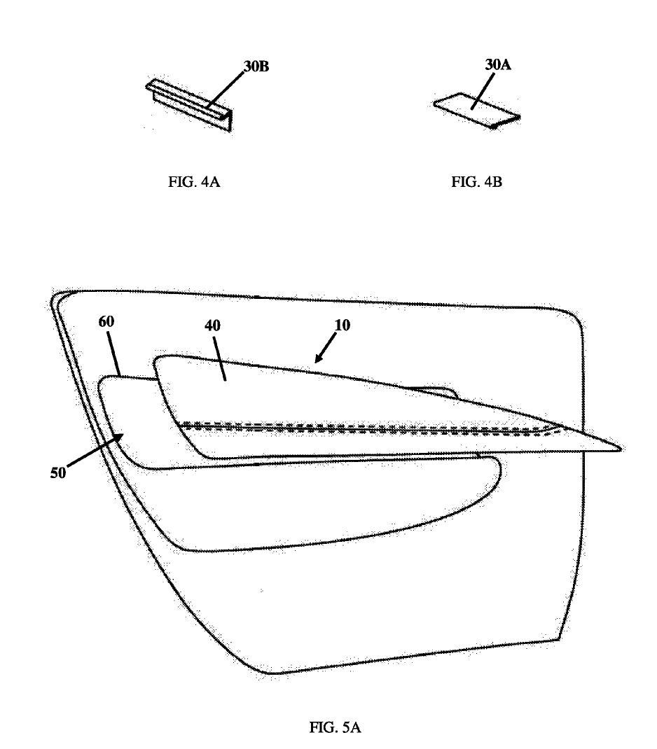

In order to securely mount the cover (10) over the lining component, a plurality of fixing means (30) may be provided on the cover (10). Preferably, the fixing means (30) may be a clip, a hook, or any like article, which may function as a fixing means. As shown in FIGS. 3A-B and 5A-B, the cover (10) may comprise a combination of two types of fixing means 30, one of which appears as a tab-like article (30A), e.g., as shown in FIG. 4B, while the other appears as a tab-like article with a hook-like structure (30B), e.g., as shown in FIG. 4A. The fixing means (30) may be positioned in such a way that it extends outwardly along the periphery of the base (20). Although it is not explicitly shown in any of the accompanying drawings, the fixing means (30) may be integral with the base (20) or a separate piece of article that may be attached to the base (20). It shall be noted that when the cover (10) is mounted to the lining component (50), the fixing means (30) may engage with the abovementioned slot (60) to form a close-fit between the cover (10) and the lining component (50). Hence, the fixing means (30) should not be visible after the cover (10) is mounted to the lining component (50). Any fixing means (30) of any shape and size that is capable of providing the aforementioned engagement effect may be utilised.

In another embodiment of the invention, the fixing means may be a double-sided tape or a hook-and-loop fastener (not shown) provided on the interior surface of the base (20). Such fixing means may be particularly preferred when a slot (60) is not available between the lining component (50) and the rest of the vehicle interior or the space in the slot (60) is not sufficiently large to allow engagement with the hook or clip fixing means (30). Preferably, the fixing means may be positioned adjacent to the periphery of the base (20) which may provide a secure mount and a close-fit between the cover (10) and the lining component (50). However, any type of the fixing means 30 (e.g., clip, hook, double-sided tape, hook-and-loop fastener and/or the like) may coexist, depending on the desired engagement performance.

In accordance with a preferred embodiment of the invention, the cover (10) may be proportionately slightly larger than the original or existing lining component (50) in terms of size so that it may be mounted over the lining component (50). However, it shall be noted that the size of the cover (10) should not be so large such that the underside of the cover (10), which is also the interior surface of the base (20), could not form a close-fit with the lining component (50). The thickness of the cover (10) may be preferably 0.5 mm to 1.2 mm, and more preferably 0.8 mm to 1.0 mm.

A further embodiment of the invention is a method of producing the interchangeable cover (10), as described in any of the preceding description, comprising the steps of molding a base (20) over an original vehicle interior lining component (50) so that it has an interior contour corresponding to the exterior shape of the component (50) to be covered, attaching a facing sheet (40) to the exterior surface of the base (20), and providing a plurality of fixing means (30) for mounting the cover (10) over the component (50).

The base (20) may be molded using any conventional molding technology such as, but not limiting to, injection molding, vacuum forming, or compression molding. Preferably, the lining component (50) may be remote from the vehicle when molding the base (20). This is to prevent unintentional damage to the vehicle interior during the molding process. After the molding process, the lining component (50) may be assembled to the vehicle interior while the base (20) may be preferably removed from the lining component (50) after molding. By using one lining component (50) from each vehicle type, multiple bases (20) for each vehicle type can be molded therefrom. Hence, it is not necessary to dismantle the lining component (50) each time to produce one cover (10).

In a further embodiment of the invention, the facing sheet (40) may be attached to the exterior surface of the base (20) before or after assembling the cover (10) to the vehicle. Preferably, the facing sheet (40) may be attached to the base (20) before assembling the cover (10) to the vehicle. However, one may attach the facing sheet (40) after assembling the cover (10) to the vehicle, but it is not preferable, as it is technically more difficult to attach the facing sheet (40) and form the fixing means (30) thereafter. Preferably, the facing sheet (40) may be attached to the base (20) by an adhesive, wherein the adhesive may be glue or double-sided adhesive tape. More preferably, the adhesive may be applied to the exterior surface of the base (20) by spraying. In order to allow a smooth adhesion between the base (20) and the facing sheet (40), it may be preferable to apply a press forming or vacuum forming process thereto, in which heat may be applied during the process. As shown in the drawings, the facing sheet (40) may have a larger surface area than the exterior surface of the base (20) so that it spans the whole exterior surface of the base (20) as well as wrapping across the periphery of the base (20) and covering a portion of the interior surface of the base (20). This could enhance the outer appearance of the cover (10).

According to a further embodiment of the invention, a plurality of fixing means may be provided on the cover (10) after attaching the facing sheet (40) to the base. In one further embodiment of the invention, the fixing means may be a double-side tape or a hook-and-loop fastener (not shown). In this case, the fixing means may be provided on the underside of the cover (10), which is also the interior surface of the base (20). When the hook-and-loop fastener is used, the hook or loop fastener may be provided on the underside of the cover (10), while the corresponding fastener may be provided over the exterior surface lining component (50). Such hook-and-loop fastener can be any commercially obtained product such as Velcro®. In another further embodiment of the invention, the fixing means (30) may be a clip or a hook. As shown in the drawings, the fixing means (30) may be attached to the periphery of the cover (10). However, the fixing means (30) may also be integrally formed with the base (20) during the molding process.

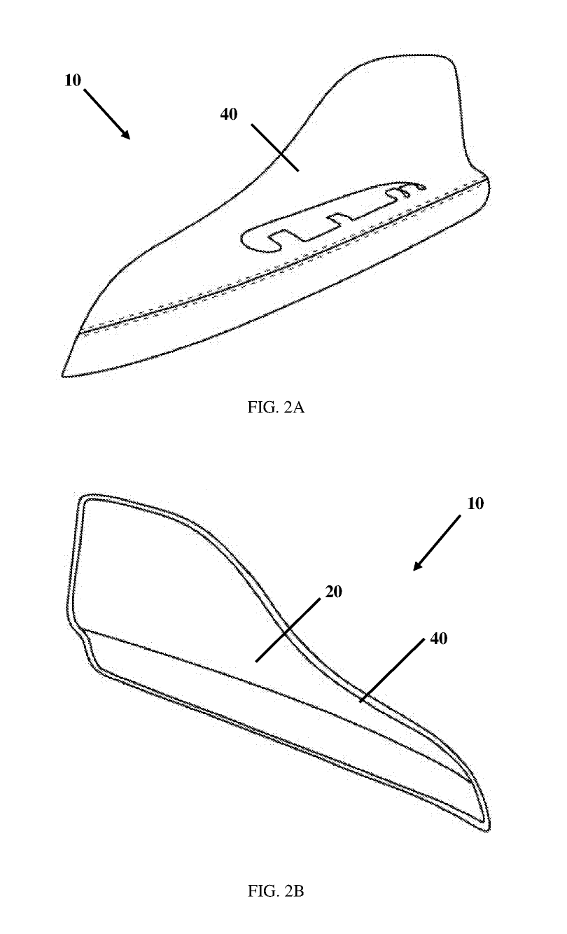

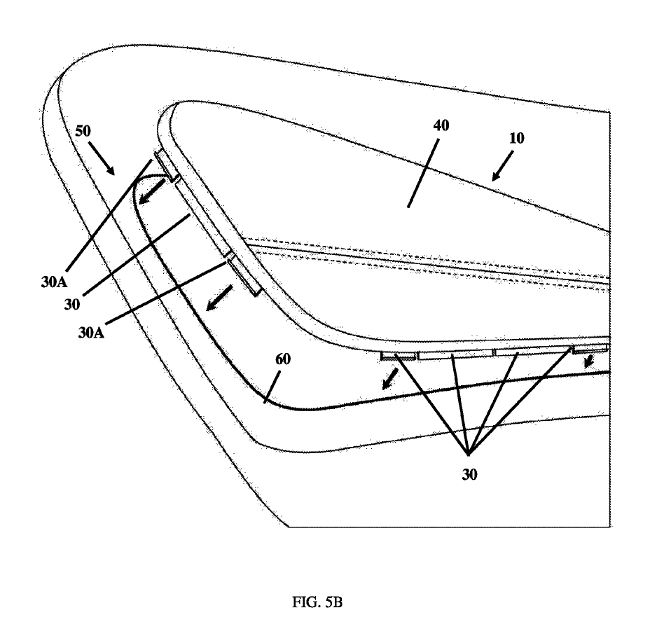

FIG. 1 illustrates a front perspective view of the cover (10) showing the surface area of the facing sheet (40) may be slightly larger than the exterior surface of the base (20). FIGS. 2A and 2B illustrate a front perspective view and a back perspective view of the cover (10) of FIG. 1 showing the facing sheet (40) attaching and wrapping across the periphery of the base (20). FIGS. 3A and 3B show a front perspective view and a back perspective view of the cover (10) in FIGS. 2A and 2B with a plurality fixing means (30) attached to the periphery of the cover (10), wherein the fixing means (30) includes a combination of a tab-like article (30A) and a hook-like article (30B). FIG. 5A shows a front view of the cover (10) over the lining component (50) of the vehicle interior before assembling. FIG. 5B shows an enlarged perspective view of the cover (10) over the lining component, as depicted in FIG. 5A, showing the engagement of the fixing means (30) with the slot (60) to form a close-fit therebetween. After mounting the cover (10) over the lining component (50), the lining component (50) should not be, and preferably is not, visible from the outside and instead, the cover (10) appears to be the lining component from the outside. Nevertheless, the original or existing lining component (50) still remains intact with the vehicle interior after mounting of the cover (10). With the use of the present interchangeable cover (10), the outer appearance of the vehicle interior lining component (50) could be improved without causing any damage to the original or existing lining component (50). The cover (10) also may serve as a protective means for the original or existing lining component (50).

Although the invention has been described and illustrated in detail, it is to be understood that the same is by the way of illustration and example, and is not to be taken by way of limitation. The spirit and scope of the present invention are to be limited only by the terms of the appended claims.

What is claimed is:

1. An interchangeable cover for at least a portion of a vehicle interior lining component, comprising:
a molded base having an interior contour corresponding to an exterior shape of the component to be covered;
a plurality of fixing means for mounting the cover over the component; and
a facing sheet attached to an exterior surface of the base.

2. The cover according to claim 1, wherein the fixing means is a double-sided tape or a hook-and-loop fastener on the interior contour of the base.

3. The cover according to claim 1, wherein the fixing means is a clip or a hook.

4. The cover according to claim 3, wherein the fixing means extends outwardly along the periphery of the base.

5. The cover according to claim 3, wherein the fixing means is integral with the base.

6. The cover according to claim 3, wherein the cover is mounted to the component by the fixing means that engages with a slot formed between the periphery of the component and the rest of the vehicle interior.

7. The cover according to claim 6, wherein the fixing means engages with the slot in a manner such that it is not visible after mounting the cover to the component.

8. The cover according to claim 1, wherein the base is made from polyethylene terephthalate (PET), acrylonitrile butadiene styrene (ABS), polypropylene (PP), or polycarbonate (PC).

9. The cover according to claim 1, wherein the facing sheet is made from leather, polyvinylchloride (PVC), polyurethane (PU), fabric, or microfiber.

10. A method of producing an interchangeable cover for at least a portion of a vehicle interior lining component, comprising the steps of:
molding a base over an original vehicle interior lining component so that it has an interior contour corresponding to an exterior shape of the component to be covered;
attaching a facing sheet to an exterior surface of the base; and
providing a plurality of fixing means for mounting the cover over the component.

11. The method according to claim 10, wherein the component is remote from a vehicle.

12. The method according to claim 10 further comprising a step of removing the base from the component after molding.

13. The method according to claim 12, wherein the facing sheet is attached to the base before or after assembling the cover to the vehicle.

14. The method according to claim 10, wherein the sheet is attached to the base by an adhesive.

15. The method according to claim 10, wherein the sheet is adhered to the base by press forming or vacuum forming.

16. The method according to claim 10, wherein the fixing means is a double-sided tape or a hook-and-loop fastener.

17. The method according to claim 10, wherein the fixing means is a clip or a hook.

18. The method according to claim 17, wherein the fixing means extends outwardly along the periphery of the base.

19. The method according to claim 17, wherein the fixing means is integrally formed with the base.

20. The method according to claim 17, wherein the cover is mounted to the component by the fixing means that engages with a slot formed between the component and the rest of the vehicle.

21. The method according to claim 20, wherein the fixing means engages with the slot in a manner such that it is not visible after mounting the cover to the component.

22. The method according to claim 10, wherein the base is made from polyethylene terephthalate (PET), acrylonitrile butadiene styrene (ABS), polypropylene (PP), or polycarbonate (PC).

23. The method according to claim 10, wherein the facing sheet is made from leather, polyvinylchloride (PVC), polyurethane (PU), fabric, or microfiber.
